(19) United States
(12) Patent Application Publication
(10) Pub. No.: US 2017/0109776 A1
(43) Pub. Date: Apr. 20, 2017

(54) System and method for generation of dynamically priced discount offers for perishable inventory to vendor-selected customer segments

(71) Applicant: GoPapaya, Inc., Newton, MA (US)

(72) Inventor: Marik Marshak, Newton, MA (US)

(21) Appl. No.: 15/291,154

(22) Filed: Oct. 12, 2016

Related U.S. Application Data
(60) Provisional application No. 62/242,373, filed on Oct. 16, 2015.

(51) Int. Cl. G06Q 30/02; G06Q 10/08; H04L 29/06

(52) U.S. Cl. CPC G06Q 30/0235; H04L 63/08; G06Q 10/087

(57) ABSTRACT

A method for generation of dynamically priced discount offers for perishable inventory to vendor-selected customer segments includes conveying, by a vendor client device on the premises of a vendor, to a server, a first message identifying an oversupply of perishable inventory. The method includes directly transmitting, by local transmitter coupled to the vendor client device, to a local receiver coupled to a customer client device, a second message identifying the vendor client device. The method includes receiving, by the vendor client device, from the customer client device, a third message redeeming a discount at the vendor.

### TECHNICAL FIELD

This invention relates to inter-device communication and authentication. More particularly, the present invention relates to generation of dynamically priced discount offers for perishable inventory to vendor-selected customer segments.

### BACKGROUND ART

Vendors of perishable items, defined as goods or services whose value changes significantly over time, face unique challenges in regulating supply and demand. A restaurant, for instance, may have a certain number of tables calculated to receive the number of customers that are likely to come during maximally busy moments, but as a result may have several vacant tables during off-peak hours, or on occasions when business is unexpectedly slow. Those vacant tables represent lost income for the proprietor of the restaurant. Similarly, food can become inedible after its expiration date passes, and some food items that are made freshly in batches can lose their appeal in a matter of hours or even minutes.

Existing solutions to this problem are inefficient and overly reliant on guesswork. Typically, a vendor of services examines the supply situation prior to the day in question, and attempts to identify the “shoulder” time when slow business is likely. The vendor may then make a discount for customers that arrive during the estimated shoulder time public, for instance by mass emailing. This approach relies on an overly distant estimate about likely demand, as an expected shoulder time could prove to be busier than anticipated; as a result, the vendor can lose money due to unnecessary discounts for customers who would have paid full price. The customers who receive the discount offer, meanwhile, may or may not remember the offer or be in the area when the time is right to redeem it. Unused discount offers can harm the vendor's brand, by creating the impression that the vendor is having difficulty attracting customers. These, and many other issues, result in a wasteful solution to the problem of slow periods for service providers. Another problem is that even when the business is supposed to be busy it does not mean that the business is at 100% capacity all the time. Still another problem that business may face is last minute cancelation, leaving the businesses with an unexpected surplus of unused services. Even worse, such unexpected surpluses are perishable inventory: they must be sold within a short time, or their value is lost.

In view of the above, there is a need for a real-time, private discount offer distribution system that enables vendors to target users likely to bring in desirable business before perishable inventory expires.

### SUMMARY

In one aspect, a method for generation of dynamically priced discount offers for perishable inventory to vendor-selected customer segments includes identifying, by a computing device, an oversupply of perishable inventory at a vendor. The method includes directly transmitting, by local transmitter coupled to the computing device, to a local receiver coupled to a customer client device, a second message identifying the vendor client device. The method includes receiving, by the computing device, from the customer client device, a third message redeeming a discount at the vendor.

In a related embodiment, conveying further involves calculating a number of consumers necessary to eliminate the oversupply. In another embodiment, directly transmitting further includes periodically broadcasting a signal identifying the vendor. In an additional embodiment, directly transmitting also involves detecting a signal transmitted by the client device and broadcasting a signal identifying the vendor in response to the detected signal. In a further embodiment, the signal transmitted by the client device also includes a redemption code. In another embodiment, transmitting further includes generating a unique identifier.

In another related embodiment, receiving also includes receiving a redemption code from the customer client device. In a further embodiment, receiving the redemption code also involves scanning the redemption code from a display of the customer client device. In another embodiment, receiving the redemption code further includes receiving the redemption code by local transmission. Another embodiment involves authenticating, by the computing device, the customer client device. An additional embodiment includes authenticating, by the customer client device, the vendor. Still another embodiment involves determining, by the computing device, that the discount has expired. Yet another embodiment includes transmitting, by the computing device, a compensatory offer to the customer client device.

A related embodiment also includes selecting, by the computing device, the customer client device and conveying, by the computing device, to the customer client device, the discount offer. In another embodiment, selecting further includes locating, by the computing device, position data of a client device used by a user, determining that the location is closer than a threshold amount, and selecting the user based on the determination. In an additional embodiment, selecting also involves determining that the user has used the vendor in the past and selecting the user profile from a plurality of user profiles. In a further embodiment, selecting also includes determining that the user has purchased inventory similar to the perishable inventory in the past and selecting the user profile from a plurality of user profiles. In another embodiment still, selecting the user further involves assigning a rank to each of a plurality of users that includes the user and determining that the user has a high rank. In yet another embodiment, the rank represents proximity of a client device used by each user to the vendor. An additional embodiment involves calculating, by the computing device, the probability that a user will redeem the discount offer and selecting enough users as the at least one user to make the probability that all oversupply substantially equal to one.

Other aspects, embodiments and features of the system and method will become apparent from the following detailed description when considered in conjunction with the accompanying figures. The accompanying figures are for schematic purposes and are not intended to be drawn to scale. In the figures, each identical or substantially similar component that is illustrated in various figures is represented by a single numeral or notation. For purposes of clarity, not every component is labeled in every figure. Nor is every component of each embodiment of the system and method shown where illustration is not necessary to allow those of ordinary skill in the art to understand the system and method.

### BRIEF DESCRIPTION OF THE DRAWINGS

The preceding summary, as well as the following detailed description of the disclosed system and method, will be better understood when read in conjunction with the attached drawings. For the purpose of illustrating the system and method, presently preferred embodiments are shown in the drawings. It should be understood, however, that neither the system nor the method is limited to the precise arrangements and instrumentalities shown.

FIG. 1A is a schematic diagram depicting an example of an computing device as described herein;

FIG. 1B is a schematic diagram of a network-based platform, as disclosed herein;

FIG. 2 is a block diagram of an embodiment of the disclosed system;

FIG. 3 is a flow diagram illustrating one embodiment of the disclosed method;

FIG. 4 is a flow diagram illustrating one embodiment of the disclosed method; and

FIG. 5 is a flow diagram illustrating one embodiment of the disclosed method.

FIG. 6 is a flow diagram illustrating one embodiment of the disclosed method.

### DETAILED DESCRIPTION OF SPECIFIC EMBODIMENTS

In some embodiments, the system and method described in the following paragraphs uses data created by transforming user information to target electronically distributed discounts more effectively to users likely to use the discounts. Some embodiments transform user data to produce metrics revealing effective discount amounts to interest particular users. Some embodiments receive real time information concerning current user movements, and use that real time information to guide the transmission of discount offers for a vendor to users whose proximity to the vendor or pattern of activity at that moment renders the users likely to redeem a discount at the vendor. In some embodiments, the discounts are offered to a subset of all users based on user profiles, real time information concerning user movements, and vendor instructions concerning characteristics the vendor desires in customers to be offered discounts. Still other embodiments use local communication between a vendor device and a user device to allow the user device to detect when the user is at the vendor and automatically redeem the discount offer, to verify user and vendor identities, and to claim the discount offer for the user without the need for in-person interaction. In some embodiments, the method enables the provision and use of discount offers to be discrete, preventing users other than the redeeming user from knowing about the existence or use of the discount offer. Some embodiments of the method further prevent fraudulent activity by the customer or vendor.

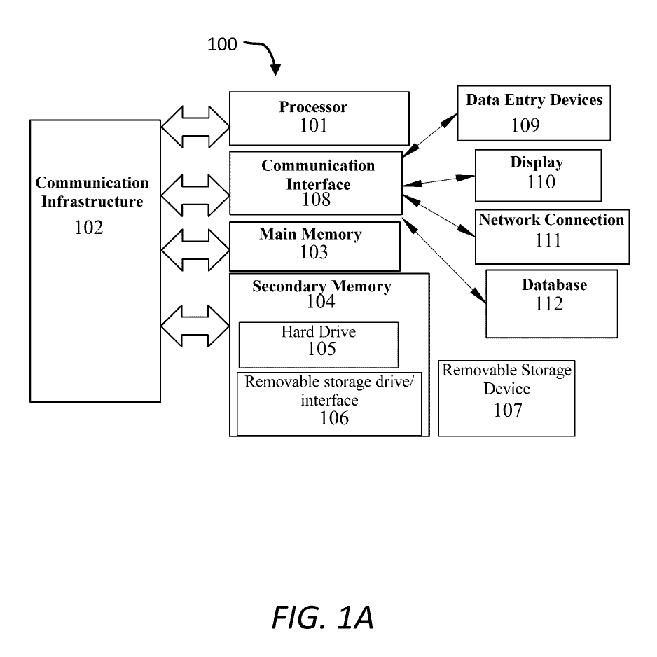

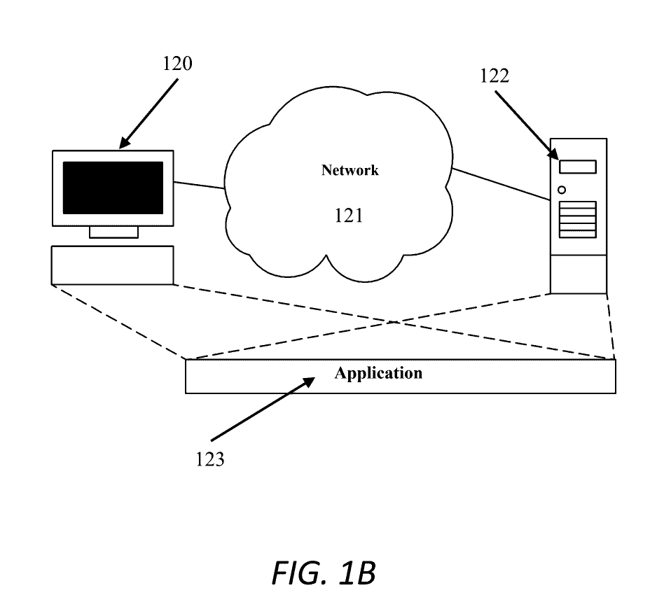

Some embodiments of the disclosed system and methods will be better understood by reference to the following comments concerning computing devices. A “computing device” may be defined as including personal computers, laptops, mobile devices such as tablets or smart phones, and any other computing device capable of supporting an application as described herein. The system and method disclosed herein will be better understood in light of the following observations concerning the computing devices that support the disclosed application, and concerning the nature of web applications in general. An exemplary computing device is illustrated by FIG. 1A. The processor 101 may be a special purpose or a general-purpose processor device. As will be appreciated by persons skilled in the relevant art, the processor device 101 may also be a single processor in a multi-core/multiprocessor system, such system operating alone, or in a cluster of computing devices operating in a cluster or server farm. The processor 101 is connected to a communication infrastructure 102, for example, a bus, message queue, network, or multi-core message-passing scheme.

The computing device also includes a main memory 103, such as random access memory (RAM), and may also include a secondary memory 104. Secondary memory 104 may include, for example, a hard disk drive or flash drive or other solid state drive (SSD) 105, a removable storage drive or interface 106, connected to a removable storage unit 107, or other similar means. As will be appreciated by persons skilled in the relevant art, a removable storage unit 107 includes a computer usable storage medium having stored therein computer software and/or data. Examples of additional means creating secondary memory 104 may include a program cartridge and cartridge interface (such as that found in video game devices), a removable memory chip (such as an EPROM, or PROM) and associated socket, a flash drive or SSD, and other removable storage units 107 and interfaces 106 which allow software and data to be transferred from the removable storage unit 107 to the computer system. In some embodiments, to “maintain” data in the memory of a computing device means to store that data in that memory in a form convenient for retrieval as required by the algorithm at issue, and to retrieve, update, or delete the data as needed.

The computing device may also include a communications interface 108. The communications interface 108 allows software and data to be transferred between the computing device and external devices. The communications interface 108 may include a modem, a network interface (such as an Ethernet card), a communications port, a PCMCIA slot and card, or other means to couple the computing device to external devices. Software and data transferred via the communications interface 108 may be in the form of signals, which may be electronic, electromagnetic, optical, or other signals capable of being received by the communications interface 108. These signals may be provided to the communications interface 108 via wire or cable, fiber optics, a phone line, a cellular phone link, and radio frequency link or other communications channels. Other devices may be coupled to the computing device 100 via the communications interface 108. In some embodiments, a device or component is “coupled” to a computing device 100 if it is so related to that device that the product or means and the device may be operated together as one machine. In particular, a piece of electronic equipment is coupled to a computing device if it is incorporated in the computing device (e.g. a built-in camera on a smart phone), attached to the device by wires capable of propagating signals between the equipment and the device (e.g. a mouse connected to a personal computer by means of a wire plugged into one of the computer's ports), tethered to the device by wireless technology that replaces the ability of wires to propagate signals (e.g. a wireless BLUETOOTH® headset for a mobile phone), or related to the computing device by shared membership in some network consisting of wireless and wired connections between multiple machines (e.g. a printer in an office that prints documents to computers belonging to that office, no matter where they are, so long as they and the printer can connect to the internet). A computing device 100 may be coupled to a second computing device (not shown); for instance, a server may be coupled to a client device, as described below in greater detail.

The communications interface in the system embodiments discussed herein facilitates the coupling of the computing device with data entry devices 109, the device's display 110, and network connections, whether wired or wireless 111. In some embodiments, “data entry devices” 109 are any equipment coupled to a computing device that may be used to enter data into that device. This definition includes, without limitation, keyboards, computer mice, touchscreens, digital cameras, digital video cameras, wireless antennas, Global Positioning System devices, audio input and output devices, gyroscopic orientation sensors, proximity sensors, compasses, scanners, specialized reading devices such as fingerprint or retinal scanners, and any hardware device capable of sensing electromagnetic radiation, electromagnetic fields, gravitational force, electromagnetic force, temperature, vibration, or pressure. A computing device's “manual data entry devices” is the set of all data entry devices coupled to the computing device that permit the at least one user to enter data into the computing device using manual manipulation. Manual entry devices include without limitation keyboards, keypads, touchscreens, track-pads, computer mice, buttons, and other similar components. A computing device may also possess a navigation facility. The computing device's “navigation facility” may be any facility coupled to the computing device that enables the device accurately to calculate the device's location on the surface of the Earth. Navigation facilities can include a receiver configured to communicate with the Global Positioning System or with similar satellite networks, as well as any other system that mobile phones or other devices use to ascertain their location, for example by communicating with cell towers. In some embodiments, a computing device's “display” 109 is a device coupled to the computing device, by means of which the computing device can display images. Display include without limitation monitors, screens, television devices, and projectors.

Computer programs (also called computer control logic) are stored in main memory 103 and/or secondary memory 104. Computer programs may also be received via the communications interface 108. Such computer programs, when executed, enable the processor device 101 to implement the system embodiments discussed below. Accordingly, such computer programs represent controllers of the system. Where embodiments are implemented using software, the software may be stored in a computer program product and loaded into the computing device using a removable storage drive or interface 106, a hard disk drive 105, or a communications interface 108.

The computing device may also store data in database 112 accessible to the device. A database 112 is any structured collection of data. As used herein, databases can include “NoSQL” data stores, which store data in a few key-value structures such as arrays for rapid retrieval using a known set of keys (e.g. array indices). Another possibility is a relational database, which can divide the data stored into fields representing useful categories of data. As a result, a stored data record can be quickly retrieved using any known portion of the data that has been stored in that record by searching within that known datum's category within the database 112, and can be accessed by more complex queries, using languages such as Structured Query Language, which retrieve data based on limiting values passed as parameters and relationships between the data being retrieved. More specialized queries, such as image matching queries, may also be used to search some databases. A database can be created in any digital memory.

Persons skilled in the relevant art will also be aware that while any computing device must necessarily include facilities to perform the functions of a processor 101, a communication infrastructure 102, at least a main memory 103, and usually a communications interface 108, not all devices will necessarily house these facilities separately. For instance, in some forms of computing devices as defined above, processing 101 and memory 103 could be distributed through the same hardware device, as in a neural net, and thus the communications infrastructure 102 could be a property of the configuration of that particular hardware device. Many devices do practice a physical division of tasks as set forth above, however, and practitioners skilled in the art will understand the conceptual separation of tasks as applicable even where physical components are merged.

The computing device 100 may employ one or more security measures to protect the computing device 100 or its data. For instance, the computing device 100 may protect data using a cryptographic system. In one embodiment, a cryptographic system is a system that converts data from a first form, known as “plaintext,” which is intelligible when viewed in its intended format, into a second form, known as “cyphertext,” which is not intelligible when viewed in the same way. The cyphertext is may be unintelligible in any format unless first converted back to plaintext. In one embodiment, the process of converting plaintext into cyphertext is known as “encryption.” The encryption process may involve the use of a datum, known as an “encryption key,” to alter the plaintext. The cryptographic system may also convert cyphertext back into plaintext, which is a process known as “decryption.” The decryption process may involve the use of a datum, known as a “decryption key,” to return the cyphertext to its original plaintext form. In embodiments of cryptographic systems that are “symmetric,” the decryption key is essentially the same as the encryption key: possession of either key makes it possible to deduce the other key quickly without further secret knowledge. The encryption and decryption keys in symmetric cryptographic systems may be kept secret, and shared only with persons or entities that the at least one user of the cryptographic system wishes to be able to decrypt the cyphertext. One example of a symmetric cryptographic system is the Advanced Encryption Standard (“AES”), which arranges plaintext into matrices and then modifies the matrices through repeated permutations and arithmetic operations with an encryption key.

In embodiments of cryptographic systems that are “asymmetric,” either the encryption or decryption key cannot be readily deduced without additional secret knowledge, even given the possession of the corresponding decryption or encryption key, respectively; a common example is a “public key cryptographic system,” in which possession of the encryption key does not make it practically feasible to deduce the decryption key, so that the encryption key may safely be made available to the public. An example of a public key cryptographic system is RSA, in which the encryption key involves the use of numbers that are products of very large prime numbers, but the decryption key involves the use of those very large prime numbers, such that deducing the decryption key from the encryption key requires the practically infeasible task of computing the prime factors of a number which is the product of two very large prime numbers. Another example is elliptic curve cryptography, which relies on the fact that given two points P and Q on an elliptic curve over a finite field, and a definition for addition where A+B=R, the point where a line connecting point A and point B intersects the elliptic curve, where “0,” the identity, is a point at infinity in a projective plane containing the elliptic curve, finding a number k such that adding P to itself k times results in Q is computationally impractical, given correctly selected elliptic curve, finite field, and P and Q.

The systems may be deployed in a number of ways, including on a stand-alone computing device, a set of computing devices working together in a network, or a web application. Persons of ordinary skill in the art will recognize a web application as a particular kind of computer program system designed to function across a network, such as the Internet. A schematic illustration of a web application platform is provided in FIG. 1A. Web application platforms typically include at least one client device 120, which is an computing device as described above. The client device 120 connects via some form of network connection to a network 121, such as the Internet. The network 121 may be any arrangement that links together computing devices 120, 122, and includes without limitation local and international wired networks including telephone, cable, and fiber-optic networks, wireless networks that exchange information using signals of electromagnetic radiation, including cellular communication and data networks, and any combination of those wired and wireless networks. Also connected to the network 121 is at least one server 122, which is also an computing device as described above, or a set of computing devices that communicate with each other and work in concert by local or network connections. Of course, practitioners of ordinary skill in the relevant art will recognize that a web application can, and typically does, run on several servers 122 and a vast and continuously changing population of client devices 120. Computer programs on both the client device 120 and the server 122 configure both devices to perform the functions required of the web application 123. Web applications 123 can be designed so that the bulk of their processing tasks are accomplished by the server 122, as configured to perform those tasks by its web application program, or alternatively by the client device 120. Some web applications 123 are designed so that the client device 120 solely displays content that is sent to it by the server 122, and the server 122 performs all of the processing, business logic, and data storage tasks. Such “thin client” web applications are sometimes referred to as “cloud” applications, because essentially all computing tasks are performed by a set of servers 122 and data centers visible to the client only as a single opaque entity, often represented on diagrams as a cloud. The cloud may be public, meaning that it is accessible to any interested user, or private, meaning that it requires user or device authentication prior to access.

Many computing devices, as defined herein, come equipped with a specialized program, known as a web browser, which enables them to act as a client device 120 at least for the purposes of receiving and displaying data output by the server 122 without any additional programming. Web browsers can also act as a platform to run so much of a web application as is being performed by the client device 120, and it is a common practice to write the portion of a web application calculated to run on the client device 120 to be operated entirely by a web browser. Such browser-executed programs are referred to herein as “client-side programs,” and frequently are loaded onto the browser from the server 122 at the same time as the other content the server 122 sends to the browser. However, it is also possible to write programs that do not run on web browsers but still cause an computing device to operate as a web application client 120. Thus, as a general matter, web applications 123 require some computer program configuration of both the client device (or devices) 120 and the server 122. The computer program that comprises the web application component on either computing device's system FIG. 1A configures that device's processor 200 to perform the portion of the overall web application's functions that the programmer chooses to assign to that device. Persons of ordinary skill in the art will appreciate that the programming tasks assigned to one device may overlap with those assigned to another, in the interests of robustness, flexibility, or performance. Furthermore, although the best known example of a web application as used herein uses the kind of hypertext markup language protocol popularized by the World Wide Web, practitioners of ordinary skill in the art will be aware of other network communication protocols, such as File Transfer Protocol, that also support web applications as defined herein.

The one or more client devices 120 and the one or more servers 122 may communicate using any protocol according to which data may be transmitted from the client 120 to the server 122 and vice versa. As a non-limiting example, the client 120 and server 122 may exchange data using the Internet protocol suite, which includes the transfer control protocol (TCP) and the Internet Protocol (IP), and is sometimes referred to as TCP/IP. In some embodiments, the client and server 122 encrypt data prior to exchanging the data, using a cryptographic system as described above. In one embodiment, the client 120 and server 122 exchange the data using public key cryptography; for instance, the client and the server 122 may each generate a public and private key, exchange public keys, and encrypt the data using each others' public keys while decrypting it using each others' private keys.

In some embodiments, the client 120 authenticates the server 122 or vice-versa using digital certificates. In one embodiment, a digital certificate is a file that conveys information and links the conveyed information to a “certificate authority” that is the issuer of a public key in a public key cryptographic system. The certificate in some embodiments contains data conveying the certificate authority's authorization for the recipient to perform a task. The authorization may be the authorization to access a given datum. The authorization may be the authorization to access a given process. In some embodiments, the certificate may identify the certificate authority.

The linking may be performed by the formation of a digital signature. In one embodiment, a digital signature is an encrypted a mathematical representation of a file using the private key of a public key cryptographic system. The signature may be verified by decrypting the encrypted mathematical representation using the corresponding public key and comparing the decrypted representation to a purported match that was not encrypted; if the signature protocol is well-designed and implemented correctly, this means the ability to create the digital signature is equivalent to possession of the private decryption key. Likewise, if the mathematical representation of the file is well-designed and implemented correctly, any alteration of the file will result in a mismatch with the digital signature; the mathematical representation may be produced using an alteration-sensitive, reliably reproducible algorithm, such as a hashing algorithm. A mathematical representation to which the signature may be compared may be included with the signature, for verification purposes; in other embodiments, the algorithm used to produce the mathematical representation is publically available, permitting the easy reproduction of the mathematical representation corresponding to any file. In some embodiments, a third party known as a certificate authority is available to verify that the possessor of the private key is a particular entity; thus, if the certificate authority may be trusted, and the private key has not been stolen, the ability of a entity to produce a digital signature confirms the identity of the entity, and links the file to the entity in a verifiable way. The digital signature may be incorporated in a digital certificate, which is a document authenticating the entity possessing the private key by authority of the issuing certificate authority, and signed with a digital signature created with that private key and a mathematical representation of the remainder of the certificate. In other embodiments, the digital signature is verified by comparing the digital signature to one known to have been created by the entity that purportedly signed the digital signature; for instance, if the public key that decrypts the known signature also decrypts the digital signature, the digital signature may be considered verified. The digital signature may also be used to verify that the file has not been altered since the formation of the digital signature.

The server 122 and client 120 may communicate using a security combining public key encryption, private key encryption, and digital certificates. For instance, the client 120 may authenticate the server 122 using a digital certificate provided by the server 122. The server 122 may authenticate the client 120 using a digital certificate provided by the client 120. After successful authentication, the device that received the digital certificate possesses a public key that corresponds to the private key of the device providing the digital certificate; the device that performed the authentication may then use the public key to convey a secret to the device that issued the certificate. The secret may be used as the basis to set up private key cryptographic communication between the client 120 and the server 122; for instance, the secret may be a private key for a private key cryptographic system. The secret may be a datum from which the private key may be derived. The client 120 and server 122 may then uses that private key cryptographic system to exchange information until the in which they are communicating ends. In some embodiments, this handshake and secure communication protocol is implemented using the secure sockets layer (SSL) protocol. In other embodiments, the protocol is implemented using the transport layer security (TLS) protocol. The server 122 and client 120 may communicate using hyper-text transfer protocol secure (HTTPS).

Embodiments of the disclosed system and methods enable vendors to accurately generate demand when there is excess supply that exists for a limited time. In some embodiments, the system can offer a discount at any time (peak or off-peak) to specific users in close proximity; the system may produce discounts shown only to limited numbers of people likely to use the discount offer. A reverse-bidding system driven by artificial intelligence calculation may produce offers likely to entice particular users with a minimal discount amount.

Some embodiments of the disclosed system and method involve the distribution of discounts for perishable items. Perishable items, as used herein, are defined as goods or services for which a vendor will recover little or no value if they remain unsold for more than a certain amount of time. For example, if a table in a restaurant remains vacant for the length of an entire meal, the sale of a meal at that table is lost to the restaurant; the meal the restaurant would sell during that time at that table may be a perishable item, because once the length of a meal has elapsed, the potential revenue that could have been realized from selling that meal is lost. Similarly, seats in a theater for a particular performance of a musical, dramatic, or cinematic event cannot be sold to customers once that performance has ended, and are unlikely to be sold once the performance has commenced. Some goods are also perishable; for instance, food cannot be sold once spoilt, and in the case of many dishes prepared in restaurants, rapidly loses its appeal if not consumed shortly after it has been prepared. Perishable inventory, as used herein, is a supply of perishable items in the possession of one or more vendors.

Perishable inventory may include prospective perishable inventory; for instance, the prospective perishable inventory may include goods or services that could be provided on demand for customers; for example in the case of restaurant, the kitchen may have a certain capacity to create food from raw materials in a given amount of time. Continuing the example, in the case of a restaurant there may be two types of product that could be provided to customers: tables for dining in and food for take out, pickup or delivery. Similarly, prospective perishable inventory may include work that other employees might be able to perform, given customers; for example, hairdressers in a salon may be present for shifts but not currently scheduled to perform haircuts. In other words, the perishable inventory of the vendor may include latent ability to produce additional perishable items; where that latent capacity is unused after a certain period of time has elapsed, the vendor may have lost potential income.

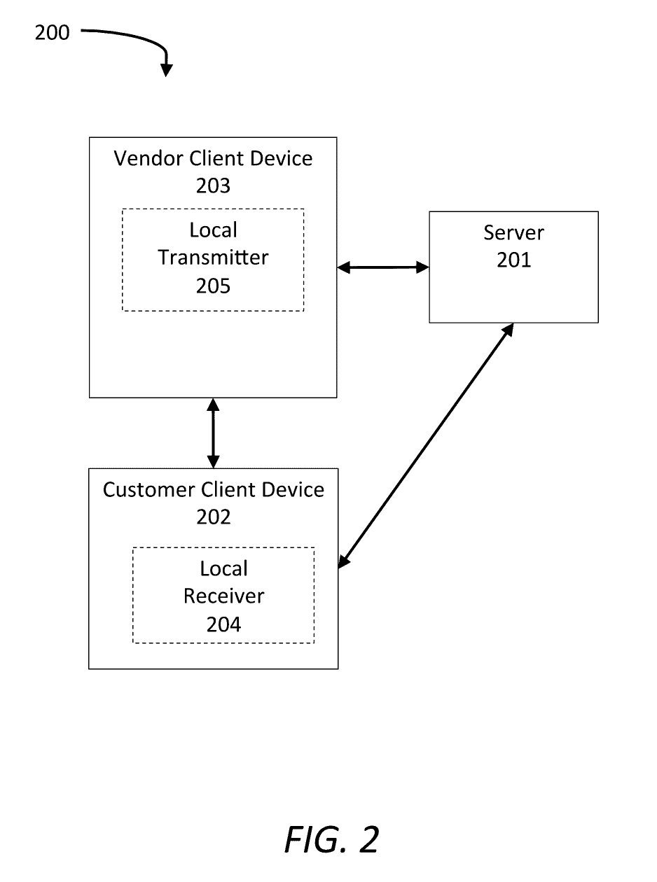

FIG. 2 illustrates an embodiment of a system 200 for real-time generation and verification of discount offers for service. As an overview, the system 200 includes a server 201. The system includes at least one customer client device 202. The system includes at least one vendor client device 203.

Referring to FIG. 2 in further detail, the system 200 includes a server 201. The server 201 may be a server 122 as described above in reference to FIGS. 1A-B. The server 201 may be a single computing device. The server 201 may be a plurality of computing devices working in concert. The devices being used as the server 201 may change over time based on load-balancing algorithms or other processes to maximize the efficiency of the use of physical resources. For instance, the server 201 may implement cloud-based architecture deployed on one or more datacenters, which may also implement other cloud applications; the particular algorithms of the server 201 may thus be performed by particular computing devices as dictated by usage patterns of this system 200 and other systems alike. As a further example, the server 201 may be implemented on a cluster of computing devices. The cluster may use redundancy, wherein a plurality of computer devices is configured to perform each task, and a plurality of copies of the same data are stored in a plurality of computers. The server 201 may store data in a Big Data platform, such as the HADOOP platform or SPARK cluster produced by the Apache Software Foundation of Los Angeles, Calif., or a similar product.

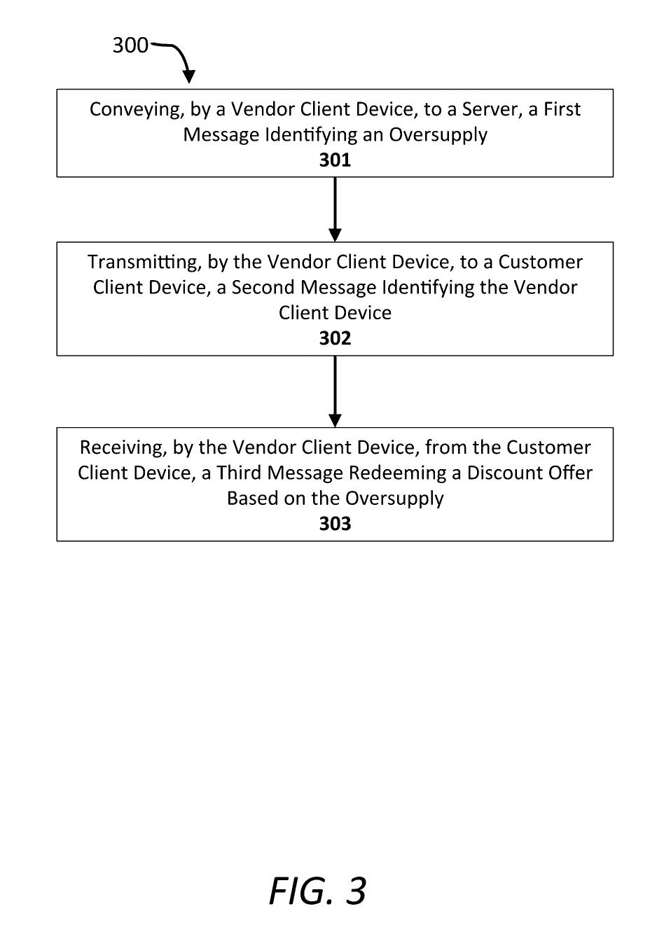

The customer client device 202 may be a client device 120 as described above in connection with FIGS. 1A-B. In some embodiments, the customer client device 202 may be carried on the person of a customer, so that the detection of the position of the customer client device 202 is substantially the same as the detection of the position of the user. For instance, the customer client device 202 may be a mobile device such as a cellular phone, a smartphone, a tablet, a laptop, a netbook, or a personal digital assistant (PDA). The customer client device 202 may be a purpose-built device configurable to perform the algorithms as described in further detail below in connection with FIG. 3.

In some embodiments, the customer client device 202 includes a local receiver 204. The local receiver 204 may be a device that permits the customer client device 202 to receive data directly from another device that is nearby. The local receiver 204 may have a communication range on the order of a few meters; the local receiver 204 may have a communication range permitting it to receive from a corresponding vendor device 203, as described below, when on vendor premises. The local receiver 204 may be a transceiver. As a non-limiting example, the local receiver 204 may be a transceiver that follows a protocol such as the BLUETOOTH protocol promulgated by Bluetooth SIG, Inc. of Kirkland, Wash. The local receiver 204 may further implement a “beacon” protocol whereby the local receiver 204 transmits or receives a substantially unique identifier associated with the customer client device 202, such as a universally unique identifier (UUID) or globally unique identifier (GUID) permitting the identification of the customer client device 202; as a non-limiting example, the beacon protocol may be implemented using the IBEACON protocol produced by Apple, Inc. of Cupertino, Calif., the EDDYSTONE protocol produced by Google, Inc. of Mountain View, Calif., or a similar protocol. The local receiver 204 may be a wi-fi transceiver.

The vendor client device 203 may be a client device 120 as described above in connection with FIGS. 1A-B. The vendor client device 203 may be a computing device operated within the premises of the vendor. The vendor client device 203 may include a plurality of computing devices operating together. The vendor client device 203 may include a mobile device. The vendor client device 203 may be incorporated in a vendor payment processing, point of sale, or order tracking system, or it may be implemented inside a reservation system such as those operated by some restaurants. For example, the vendor client device 203 may include one or more tablets operated by employees within the vendor, which may be in communication with a main computer; the main computer may be local or remote. In some embodiments, the vendor client device 203 is configured to convey, to the server 201, a first message identifying an oversupply, to transmit to the customer client device, a second message identifying the vendor client device, and to receive, from the customer client device, a third message redeeming a discount offer redeemable by at least one user, as set forth in further detail below in connection with FIG. 3.

In some embodiments, the vendor client device 203 includes a local transmitter 205. The local transmitter 205 may be a device that permits the vendor client device 203 to transmit data directly to another device that is nearby. The local transmitter 205 may have a communication range on the order of a few meters; the local transmitter 205 may have a communication range permitting it to transmit to a corresponding customer device, as described below, when the customer device is on vendor premises. The local transmitter 205 may be a transceiver. As a non-limiting example, the local transmitter 205 may be a transceiver that follows a protocol such as the BLUETOOTH protocol promulgated by Bluetooth SIG, Inc. of Kirkland, Wash. The local transmitter 205 may further implement a “beacon” protocol whereby the local transmitter 205 transmits or receives a universally unique identifier (UUID) or globally unique identifier (GUID) permitting the identification of the vendor client device 203; as a non-limiting example, the beacon protocol may be implemented using the IBEACON protocol produced by Apple, Inc. of Cupertino, Calif., the EDDYSTONE protocol produced by Google, Inc. of Mountain View, Calif., or a similar protocol. The local transmitter 205 may be a wi-fi transceiver, wi-fi hub, or wi-fi hotspot. The local transmitter 205 may be integrated in the vendor client device 203, or the local transmitter 205 may an external device coupled to the vendor client device.

FIG. 3 illustrates some embodiments of a method 300 for generation of dynamically priced discount offers for perishable inventory to vendor-selected customer segments. The method 300 includes identifying, by a computing device, an oversupply of perishable inventory at a vendor (301). The method 300 includes transmitting, by the computing device, to a customer client device, a second message identifying the vendor (302). The method 300 includes receiving, by the computing device, from the customer client device, a third message redeeming a discount offer based on the oversupply (303).

As a non-limiting illustration, in some embodiments the vendor client device 203 transmits data to the server 201 indicating the existence of some excess perishable inventory, such as vacant restaurant tables or theater seats, along with other data such as the maximum discount amount the vendor will accept, and the categories of users the vendor is interested in attracting. Continuing the example, the server 201 may select a set of users having user profiles stored on the server 201, and transmit to customer client devices 202 used by those users offers for discounts of amounts equal to or less than the maximum; the precise amount offered each user may depend on user profile and modeling algorithms performed by the server 201. Further continuing the example, the vendor client device 203 may transmit a beacon identifying the vendor client device 203, so that when a customer client device 202 arrives at the vendor premises, the customer client device 202 will detect the vendor client device 203 transmission, and send a message to the server 201 requesting the redemption of the discount offer; the server 201 may then send the discount redemption information to the vendor client device 203. Other embodiments of the method, and further details elucidating method steps, may be found in the paragraphs that follow.

Referring to FIG. 3 in greater detail, and by reference to FIG. 2, the vendor client device conveys a message to the server indicating an oversupply (301). In some embodiments, the vendor (i.e., an employee or proprietor of the vendor business) enters an instruction indicating the number of users the vendor needs; for instance, the vendor may enter a number of tables or seats at a restaurant, or other perishable inventory, that appear likely to remain unused if no action is taken. The vendor may enter the instruction on the vendor client device 203. In other embodiments, system 200 calculates the amount of probable excess supply using data describing vendor use patterns. As an example, the system 200 may have access to an application that records perishable inventory, such as seating assignments in a restaurant or theater, and keeps track of vacant and filled seats; for instance, the system 200 may determine the number of likely empty seats over a certain future period such as the length of a show or an average meal. For instance, the system 200 may obtain data from a vendor's inventory system, from a reservation system in the case of a restaurant, or from a point of sale (POS) system, to determine the amount of currently unused perishable inventory. The determination may involve computing the probability that a given number of empty seats will be filled within a particular time slot. The probability may be calculated according to a formula stored on vendor client device 203 or server 201; in some embodiments, the formula is entered by a user, for instance during manufacture or initialization of the server 201 or vendor client device 203.

In other embodiments, the formula is calculated using data concerning past patterns of consumption of the perishable inventory in question; the patterns may be specific to the individual vendor or to a particular class of vendors (e.g. restaurants, particular cuisines, fine dining versus casual dining), or the patterns may be collected more generally. The formulas used to calculate the probability may vary according to the times of day or day of the week; for instance, a large number of empty restaurant seats on a Friday night may be likely to fill up fast, while a relatively small number may be likely remain vacant on Monday night. Additional considerations to calculate the probability that a particular quantity of perishable inventory will be filled may include special events that happen in the area (some sporting event), bad or good weather, major political events, low or high tourist session, school year versus school vacation, special TV shows that impact demand, special holidays, and the like. Another source of data used to calculate the probability may be using the demand level at nearby vendors of a similar type: if the other vendors are full, it may be more probable that other customers will attend the vendor. The time slot may be selected as the maximum time within which the oversupply must be used before the vendor loses money; for instance, the time slot of one average meal may be the amount of time within which a restaurant must fill an empty table in order to avoid losing money on that table.

In some embodiments, the vendor client device 203 performs the calculations to determine the number of users the vendor needs to avoid a loss. In other embodiments, the vendor client device 203 conveys data to the server 201, which calculates the number of users. The vendor client device 203 may send any data described above in reference to FIG. 3 to the server 201. The server 201 may use any of the methods described above in connection with FIG. 3 to calculate the number of users that the vendor needs. In other embodiments, part of the calculation is performed by the vendor client 203, and part of the calculation is performed by the server 201. As a non-limiting example, the vendor client device 203 may determine the number of currently vacant seats and regularly convey data concerning the business at the vendor to the server 201, which may calculate the likely number of users needed; in other embodiments, a “thin client” system may be used in which the vendor client 203 serves as a conduit of data to the server 201, which performs all calculations. The use of past data concerning customer behavior regarding the vendor to estimate the probable number of users necessary to fill the oversupply results in a more efficient calculation of the number of users to offer a discount than a system that uses a non-vendor-specific shoulder time estimate to calculate the needed volume. Moreover, by calculating the number of users needed and transmitting the discount offers on demand at the moment users are needed to fill the oversupply, the system 200 is able to convey discount offers to a smaller and more targeted group of users, as set forth in further detail below.

In other embodiments, the system 200 determines the amount of prospective perishable inventory. The system 200 may determine the capacity of the vendor to create additional inventory based on information supplied by the vendor. For example, food for takeout may be created on demand, so the system 200 may determine that the kitchen of a restaurant can create more food then there is current demand for by the dinners in the restaurant or by people that have currently entered orders for pick up or delivery; in this case the system 200 may calculate how much more food the restaurant can create. Further continuing the example, the system 200 may base its calculation on information concerning the number of people in the kitchen, the past patterns of how fast the people in the kitchen can create food, and the actual raw material that exists in the kitchen. Similarly, the system 200 may determine, for other kinds of vendors with the capacity to produce goods or services on demand, the capacity to produce goods or services in excess of the current or projected demand for those goods or services. The system 200 may offer discounts on goods or services that may currently be produced given the capacity for production as determined above as a result; those prospective goods or services may be treated equivalently to currently existent perishable goods or services as set forth in connection with FIG. 3 and described in further detail herein. This calculation may be performed by the vendor client device 203 or by the server 201.

In some embodiments, the vendor client device 203 conveys additional information to the server 201. For instance, the vendor client device 203 may send the server 201 data describing the maximum amount of the discount that the vendor is willing to accept. The additional data may specify who is the target audience that supposed to be able to see the discount offer or offers; for instance, the vendor may be particularly interested in attracting new customers, existing customers, tourists, customers in a particular age range, customers in a particular income range, or other customers having other characteristics, as consistent with applicable law.

In some embodiments, the system 200 generates a discount offer redeemable by at least one user. The vendor client device 203 may have data identifying a plurality of users that are potential recipients of the discount offer. The system 200 may have access to a plurality of user profiles; the user profiles may be stored locally by the vendor client device 203. The user profiles may be stored remotely by the server 201, using a cloud-based storage protocol or any other server-side data storage protocol. A user profile of the plurality of user profiles may be created when a user makes use of the system 200; for instance, the user may provide profile data when the user obtains a customer client device 202 allowing the user to interact with the system 200. The user profile may be created when the user purchases from a vendor that uses the system. The user profile may be created from external sources; for instance, the user may have a social network account, and the profile may be generated based on that account. The profile may be further populated by user activities. The user activities include user interactions with the system 200. The user activities may include user interactions with vendors. The user activities may include user activity with outside sources, such as search histories and social network interactions. The user activities may include user location, and interaction with other vendors, which may be collected from the customer client device 202 and vendor devices and periodically used to augment the user profile.

The attributes tracked by the user profile may include what kinds of product the user prefers, as determined by the user's past interaction with or interest in different offers; for instance, for a past deal offered to the user, the user's degree of interest in the service offered may be determined from whether the user acted on the deal or not. The user profile may contain information indicating whether the user is a new customer or existing customer to the vendor. The user profile may determine where the user lives; in some embodiments, this is based on user-entered data, such as the user address. In other embodiments, the customer client device 202 sends periodic updates to the server 201 concerning the client position; the server 201 may examine where the user spends most of his time at night, based on the updates. Similarly, the server 201 may determine where the user works or studies by examining where the user spends most of his time during the day on weekdays. The system 200 may determine the approximate age of the user by looking at the various businesses the user visits, including both businesses participating in the system 200 and other businesses, for example by using combined location and map data to identify the businesses, and determine which type of business the user visits; the system 200 may also use social network information to determine the user's age group. Using similar habitual data, the system 200 may determine that the user is a tourist, because the user is not currently located near to the user's places of work or repose. Models predicting user reaction to discount amounts may also be included in the user profile.

In some embodiments, the server 201 generates the discount offer. In other embodiments, the vendor client device 203 generates the discount offer. The server 201 and vendor client device 203 could each perform part of the process of generating the discount offer; for instance, the vendor client device 203 may generate an amount and duration for the offer, and the server 201 may select users to send the discount offer to as set forth in further detail below.

In some embodiments, the system 200 builds a model of likely user behavior for each user of a plurality of users. The model may be based on large amount of data that is collected concerning the user; the data may be any data used to create or populate user profiles. In some embodiments, parallel algorithms are used to build a behavior model rapidly for each user. The model may generate predictions based on past user behavior. The model may generate predictions based on previous behavior by other users having a connection to the user, such as “friends” on social networks. The model may provide different predictions based on particular contexts, such as the time of the day, the vendor, the discount offer and other contributing factors. The user model may permit the system 200 to be more efficient than systems that offer discounts to random people, by acting on predictions that increase the likelihood that the user will accept a discount offer generated on demand, as described in further detail below

In some embodiments, the model is built by the server 201. In other embodiments, the vendor client device 203. The model may be built by a combination of the vendor client device 203 and the server 201.

The users of the plurality of users may be ranked by the system 200. In some embodiments, the ranking is performed by the vendor client device 203. In some embodiments, the ranking is performed by the server 201. The ranking may be global to all vendors, or the ranking may be specific to each vendor or to a class of vendors; in other words a user of the plurality of users may be ranked higher for restaurants than for theaters, or may be ranked higher for one restaurant than for another. In some embodiments, the users are ranked according to buying preferences. In other embodiments, the users are ranked according to consistency; in other words, the user may be ranked according to how likely the user is to succeed in redeeming an offer once the user has reserved a perishable item for the offer, as set forth in further detail below. The user may be ranked according to honesty; for instance, a first user that indicates the first user will claim a first discount offer, as described in further detail below, and does not attempt to do so, may be ranked lower than a second user that indicates that the second user will claim a second discount offer, and attempts to claim the second discount offer. The vendor or the system 200 may decide not to offer deals to users with an honesty rating bellow some threshold; alternatively, the vendor or system 200 may decide to offer deals to customers with low honesty rankings only if they are very close to the vendor, the system 200 may offer users with low honesty ratings offers to less desirable vendors, or the system 200 may decide to offer them discounts having lesser amounts than similar users with higher honesty rankings.

A user of the plurality of users may be ranked according to how frequently the user makes purchases with vendors in the system 200. The user may be ranked according to how frequently the user redeems discounts in the system 200. The user may be ranked according to the rank of associated users; for instance, “friends” or “connections” with the user on social media having high ranks may increase the rank of the user. The user may be ranked according to additional traits as well. In some embodiments, the ranking for each user generated by the system 200 improves the efficiency with which the system 200 selects users to send discount offers, as compared to a system that selects the users without the use of the ranking.

The system 200 may select at least one user of the plurality of users who will receive a discount offer. In some embodiments, the system 200 selects the at least one user based on the likelihood that the at least one user will attempt to redeem the discount offer. For instance, the system 200 may select users that are nearby. The system 200 may receive, from a customer client device 202 associated with the at least one user, information indicating the geographical location of the customer client device 202 according to a navigation facility coupled to the customer client device 202; the system 200 may compute the distance from that geographic location to the vendor, and select the at least one user if the distance is below a threshold amount. The system 200 may compare the geographic location to map data, and select the at least one user if it is probable that the at least one user can arrive within a threshold period. The system 200 may determine, using motion detection data from the user's customer client device 202, whether the at least one user is riding a vehicle or walking. The system 200 may select the at least one user based on how many other users of the plurality of users are also within the threshold period or distance of the vendor. In some embodiments, where there are multiple users within the time or distance threshold of the vendor, the system 200 selects the at least one user based on which user is nearest to the vendor; nearest may mean closest geographically, or the smallest amount of time away from the vendor. In other embodiments, if a greater number of users within the threshold area are available than necessary for the vendor's needs, the at least one user is selected from among them at random or according to rankings as calculated above.

The system 200 may select the user based on other factors, such as whether the user is a new customer or exiting customer, whether the user is tourist, what the user's age range is, what the user's income range is, what the user's honesty ranking is, or how many other offers the user has redeemed lately. Alternatively, the system 200 may not have a geographical or temporal threshold, but may rank users according to proximity and select the closest users. The system 200 may select the at least one user based on the at least one user's ranking; in some embodiments, the system 200 selects the at least one user by means of a combination of factors, such as selecting high-ranking users that are within a geographic or time-based threshold of the vendor. The system 200 may use different factors to select users in different areas; for instance, the factors used to select the at least one user in New York City may differ from the factors used to select the at least one user in Boston. By using real-time geographic and other data for selecting users that are more likely to redeem the discount offer at a particular moment, the system 200 may ensure that the users that receive discount offers are more likely to redeem the discount offers, enhancing the probability that the oversupply will be filled. In some embodiments, the system 200 calculates the probability that each at least one user will redeem the discount offer, and selects enough users as the at least one user to make the probability that all oversupply will be used as close as possible to one. In some embodiments, where the vendor has entered the consumer characteristics the vendor prefers to emphasize, as described above in connection with FIG. 3, the system 200 may select users having one or more of the vendor's preferred consumer characteristics. In some embodiments, by offering discounts only to users likely to redeem them, the system 200 avoids providing each user with too many discounts; as a result, the customer may not be overloaded with offers that do not meet their taste, and thus be more likely to notice and redeem a discount offer that the customer finds desirable.

In some embodiments, the system 200 determines the magnitude of the discount to offer each of the at least one user. The vendor client device 203 may make this determination. The server 201 may make this determination. In some embodiments, both the server 201 and the vendor client device 203 perform part of the process to determine the magnitude of the discount. There may be a maximum discount amount; for instance, a particular vendor may enter an instruction specifying the maximum amount on the vendor client device 203 corresponding to that vendor, and as a result the system 200 may establish discount offers for that vendor that are less than or equal to the maximum amount. The system 200 may determine the maximum discount level automatically by calculating the profit margin the vendor has for each perishable item in question; the system 200 may calculate the profit margin using factors including purchase price of the item by the vendor, the purchase price paid for materials used to produce the item, labor cost to produce and sell the item, facility cost to produce or sell the item, and other fixed costs that the vendor incurs in connection to selling the product.

In some embodiments, the system 200 adjusts the amount of the discount based upon the user's profile. For example, the model the system 200 generates for one at least one user may predict that the at least one user will likely redeem a discount for less than the maximum; as a non-limiting example, the vendor maximum discount may be 10%, but the model corresponding to this at least one user may indicate that the at least one user would accept a discount offer of 5%. The model may base this prediction on previous discount offers the at least one user has redeemed, or on any other factors used to generate the at least one user profile, such as past spending behavior or the discount or spending behavior of users related by social networks. In some embodiments, the system 200 uses a reverse bidding algorithm to obtain the most users in exchange for the least discount. For instance, if several of the plurality of users are close enough to the vendor to redeem discounts, but some would require a 10% discount to motivate them while others would require only a 5% discount to motivate them, the system 200 may send 5% discount offers to all users likely to accept 5% discounts, and send relatively few 10% discounts to the remaining users, ensuring that the majority of discounts redeemed are for 5%.

The system may use machine-learning algorithms to determine the user's likely behavior for the model. For instance, the system 200 may engage in a classification algorithm using the user's past behavior. In one embodiment, the system 200 finds one or more factors that a sample of user-accepted offers have in common, and saves that one or more factors as a hypothetical set of factors that will encourage the user will accept offers. The hypothetical set of factors may be saved as a decision tree. The system 200 may then test the hypothetical factor set by checking whether data concerning additional past user interactions is consistent with the hypothetical factors. In other embodiments, the system may test the hypothetical factor or factors using an A/B test, for instance by offering the user competing discount offers, some of which include a hypothetical factor, and some of which do not, and recording which offers the user accepts. Where there is a paucity of data or a lack of time to test the user, the system may derive the hypothetical factors or decision trees from analysis of similar users' data, may test the hypothetical factors against similar users' past data, or may perform a battery of A/B tests by spreading the tests among a cohort of several similar users in lieu of performing a series of such tests on the user; for instance, each factor may be tested on a small number of similar users, rather than all factors begin tested on a single user. Similar users may be selected by comparing user profiles; for instance, a user in a similar geographic region, performing a similar kind of work, and in a similar age group may be treated as a similar user. In other embodiments, a similar user is a user that is closely linked to the user on a social network.

In other embodiments, the system 200 builds the model using a collaborative filtering algorithm. For example, if the user is associated with other users in a social network, the system 200 may determine the discount amounts sufficient to induce the user's friends to make purchases, and use that to predict the discount amount that the user would be likely to accept for various services; the system 200 may, for instance predict that the user is likely to respond well to a discount representing the mean effective discount for the related users. The system 200 may find a plurality of users that have purchased one or more similar items to the user, and average their accepted discount amounts for a given kind of service to estimate the user's likely discount; the average may be weighted by the number of common purchases a given user of the plurality has with the user, so that a person that bought 10 items the user also bought contributes more to the average than a person that only bought 5 items the user also bought. This collaborative filtering may use data concerning purchases of goods or other things not covered by the discounts in the system to compute how similar users' tastes are.

In addition to calculating the discount amount the at least one user is likely to accept, the system 200 may adjust the amount of the discount offer according to the relevant demand, or in other words according to the demand available to fill the perishable inventory before it expires. The amount offered may depend on the number of other clients in the vicinity of the vendor who also qualify to get the offer. For example, the system 200 may determine that the user has a probability of 50% of accepting a 10% discount and a probability of 25% of accepting a 5% discount; if the probabilities are similar for other local users, and there are enough of them that 25% of them would fill the inventory, the system 200 may offer 5% discounts rather than 10% discounts, even if it risks more users turning the discounts down.

In some embodiments, other factors affect the amount of the discount offered to the at least one user. The history of the visitation of the at least one user to the vendor may affect the amount offered; for example, if the at least one user has never visited the vendor before, the system 200 may offer a greater discount as an incentive to try the vendor for the first time. Likewise, the system 200 may offer higher discounts to reward loyalty in the case of an at least one user who regularly frequents the vendor. In some embodiments, by offering each user a discount amount likely to entice that user based on the user's past behavior, the system 200 saves the vendor from having to offer a greater discount than necessary to sell the perishable inventory; this is in contrast to previous methods, where non-personalized discounts necessarily must offer more than necessary to interest some users, in order to fill the vendor's need for instantaneous demand, or risk leaving the inventory unsold.

In some embodiments, the system 200 determines a duration of the discount offer. For the purposes of the ensuing paragraphs, the term “duration” will refer to the maximum time that the discount offer is available, while the term “hold time” will refer to the maximum time the at least one user has to redeem an offer after requesting that it be reserved, prior to the offer being available to all users again, as described below in further detail. Either the server 200 or the vendor client device 203 may determine the duration of the discount offer. In some embodiments, the duration of the discount offer is based on the time slot described above in connection with FIG. 3. The duration may be selected as the time within which the perishable inventory expires, or in other words the maximum time within which the oversupply must be used before the vendor loses money; for instance, a duration of one average meal may be the amount of time within which a restaurant must fill an empty table in order to avoid losing money on that table. The duration may be based on the amount of time before a particular empty seat is scheduled to be occupied; for instance, a table may be empty until a previously scheduled reservation is seated, or a seat in a theater may be available until the next show. In other embodiments, the system 200 interacts with vendor scheduling data to determine when the vendor is open to business; likewise, as described above, the system 200 may interact with reservation systems to determine when more customers are expected to come and when the inventory level available to sell at discount will vanish. The system 200 may also check how much manpower the vendor has on the floor to sell the perishable inventory, or the latent capacity to produce inventory as set forth in further detail above. Alternatively, the vendor may enter an instruction on the vendor client device 203 specifying what the duration should be. In some embodiments, the duration is transmitted to the at least one user with the discount offer, as described in further detail below. In other embodiments, the duration is not transmitted to the user; instead, if the at least one user attempts to redeem the discount offer after the duration has lapsed, the system 200 will not permit the at least one user to redeem the offer. The at least one user may be offered a compensatory offer in this case, as discussed in further detail below.

In some embodiments, the system 200 transmits the discount offer to the at least one user; the system 200 may do so by transmitting the discount offer to the at least one customer client device 202 associated with the at least one user. In some embodiments the server 201 transmits the discount offer. Where the vendor client device 203 generated the discount offer, the vendor client device 203 may transmit the discount offer to the server 201. The server 201 may transmit the discount offer to the customer client device 202 using any form of electronic communication. The server 201 may transmit the discount offer using electronic mail (email), according to a protocol like the Simple Mail Transfer Protocol (SMTP) or Post Office Protocol (POP). The offer may be sent to the customer client device 202 using an application programming interface (API) such as the REST API. The offer may be sent using a push notification, for instance as used for conveying messages in mobile applications. In some embodiments, whenever the at least one user views the application for viewing discount offers on the customer client device, the customer client device 202 automatically sends a request to the server 201 for discount offers, and the server 201 responds with offers relevant to the user at that time. The server 201 may transmit the discount offer according to another protocol such as file transfer protocol (FTP) the hypertext transfer protocol (HTTP), or the hypertext transfer protocol secure (HTTPS). The server 201 may communicate with a corresponding application on the customer client device 202. In some embodiments, the vendor client device 203 sends the discount offer to the customer client device 202. Where the customer client device 202 is sufficiently close to the vendor client device 203 to communicate directly, the vendor client device 203 may send the discount offer directly using, for example, radio frequency communication, including without limitation “wife” communication. The vendor client device 203 may send the discount offer via a remote device such as another server. The vendor client device 203 may send the discount offer via another protocol such as the Short Message Service (SMS) text messaging protocol.

In some embodiments, the discount offer contains text describing the discount offer. For instance, if the discount offer is sent via email, the email may contain a text describing the vendor, and the amount of the discount; the text may also describe terms and conditions pertaining to the discount, such as any limitations on services for which the discount is available. In some embodiments, the text also describes the duration of the discount offer; the described duration may be described in terms of a duration of time, such as 30 minutes, or an ending time. In other embodiments, the time limit is not described to the user; the time limit may not be sent to the customer client device 203.

The discount offer may include a redemption code that must be used to redeem the discount offer. The redemption code may be in the form of any textual, binary, or other data. The redemption code may represent a transaction number. In some embodiments, the redemption code is displayed to the at least one user. The redemption code may be displayed, for instance, as an alphanumeric sequence, a bar code or quick read (QR) code, or in another visible form. In other embodiments, the redemption code is stored on the customer client device 202 but not displayed to the at least one user. For instance, the redemption code may be retrievable only by electronic communication between the vendor client device 203 and the customer client device 202; the customer client device 202 may further be configured to convey the code to the vendor client device 203 only after authenticating the vendor client device 203 as set forth in further detail below. In other embodiments, the redemption code is stored on the server 201; the redemption code may instead be sent from the server 201 to the vendor client device 203 when the customer client device 202 detects the transmission identifying the vendor client device 203. The redemption code in that case may be created when the customer indicates they want to “hold” the offer, as described in further detail below. In some embodiments, each redemption code is unique, and is sent to both the customer client device 202 and the vendor client device 203. The vendor may use the unique redemption code for further authentication of the client, if the vendor suspects suspicious activity, or wishes to ensure security for any other reason.

In some embodiments, the at least one user enters an instruction on the customer client device 202 indicating that the at least one user intends to redeem the discount offer. The customer client device 202 may convey the instruction to the system 200; in some embodiments, the customer client device 202 conveys the instruction to the server 201. The server 201 may in turn convey the instruction to the vendor client device 203. The system 200 may reserve at least one perishable item for the user, based on the instruction; in other words, the system 200 may reduce by at least one the number of available perishable items for other users to claim. In some embodiments, upon receiving the instruction, the system 200 generates a hold period, which is a time limit within which the at least one user must arrive at the vendor to redeem the discount offer. The hold period may be calculated by the server 201 or the vendor client device 203. The hold period may be limited to no more than the end of the duration described above in reference to FIG. 3; for instance, if the duration of the discount offer is scheduled to end in 30 minutes, the system 200 may generate a hold period of 30 minutes or less. The length of the hold period may depend upon other factors as well. The length of the hold period may depend on the geographical region within which the vendor is located; for instance, the hold period length may be different in New York City than it would be in Boston. As an illustration, it may be that it takes a longer time in New York City to get from point A to B than it does in Boston, and thus hold times may be longer in New York City; nonetheless, hold times may still be bounded by the duration of the offer, which may cause the system 200 to transmit offers to users within a smaller radius in New York than it would in Boston, so that users can obtain hold times that are less than or equal to the duration. The length of the hold period may also depend on the time of day, the traffic conditions, or whether the at least one user is on foot or riding on a vehicle, as discussed above for computing the duration in connection with FIG. 3. Likewise, the hold period may depend on how many other users are in the area; for instance, if there are a large number of users that are closer to the vendor than the at least one user, then the hold period may be reduced owing to the relatively higher probability that one of those users would redeem the discount offer more quickly. The hold time may also depend on how many free perishable items the vendor has and for how long the system 200 estimates they will remain empty; for instance, if the perishable items are likely to remain unused for a long time, the system 200 may create longer hold times. In some embodiments, the hold period is transmitted to the at least one user; for instance, the server 201 may transmit the hold period to the customer client device 202 which may display the hold period to the at least one user. In other embodiments, the at least one user is not provided with the hold period.

In some embodiments, the system 200 allows more users to enter the instruction indicating an intention to redeem the discount offer than there are perishable items available for the discount offer. The system 200 may calculate the number of users to allow to enter the instruction based on a formula computing the probability that a user that has entered the instruction will arrive in time to claim it. This probability may also vary by vendor, category of product, time of the day, day of the week, and other similar factors. As a non-limiting example, data concerning past discount offers may indicate that 80% of users who enter the instruction will probably redeem the discount offer on time, and that the remaining 20% will likely either arrive too late or not show up at all; as a result, the system may allow users to enter instructions regarding 125% of the total perishable items available. In some embodiments, the system 200 includes a safety margin of a certain number of unassigned perishable items so that an unexpectedly high number of redeeming users will still likely be able to redeem their discount offers. In other embodiments, the system 200 provides compensatory offers, as described in further detail below, to overbooked users.

The method 300 includes transmitting, by the vendor client device, to a customer client device, a second message identifying the vendor client device (302). In some embodiments, the vendor client device 203 uses its local transmitter 205 to send out the vendor identifier periodically. In other embodiments, the vendor client device 203 sends out the identifier upon detecting that another device is on premises; for instance, the customer client device 202 may attempt to pair with the vendor client device 203.

The method 300 includes receiving, by the vendor client device, from the customer client device, a third message redeeming a discount offer based on the oversupply (302). In some embodiments, the vendor manually enters a redemption code on the vendor client device 203. In other embodiments, the vendor client device 203 scans the code; for instance, the vendor may read the redemption code from the display of the customer client device 202 and enter the redemption code on the vendor client device 203. In other embodiments, the vendor client device 203 scans the redemption code from the customer client device 202, for instance using near field communication or by scanning a QR code or bar code from the customer device 202 display.

In other embodiments, a local transmitter 205 coupled to the vendor client device 202 receives, from a local receiver 204 coupled to the customer client device 202, the third message. The local transmitter 205 may detect that the at least one user has entered the venue; the local transmitter 205 may detect this by detecting that the local receiver 204 is transmitting the redemption code. In other embodiments, the local transmitter 205 detects the location of the local receiver according to a transceiver protocol for detection such as the IBEACON or EDDYSTONE protocols described above, and upon detection receives the redemption code from the local transmitter 205. In some embodiments, the customer client device 202 authenticates the vendor client device 203 prior to sending the redemption code; for instance, in some embodiments, the customer client device 202 receives a UUID or GUID from the vendor client device 203 and compares that identifier to an identifier of the vendor stored in memory accessible to the customer client device 202. The customer client device 202 may also convey the identifier supplied by the vendor client device 203 to the server 201 for authentication. The use of automatic local communication between the vendor client device 203 and the customer client device 202 allows for a more rapid verification of the discount offer, while permitting the redemption of the offer, as well as other details such as its amount, to remain private with respect to other users.

In other embodiments, upon receiving the transmission from the vendor client device 203, the customer client device 202 sends a message to the server 201. The message may contain the vendor client device 202 identifier. The message may contain an identifier of the discount offer. The server 201 may then send a message to the vendor client device 203 instructing the vendor client device 203 to apply the discount. The message may include the redemption code. The server 201 may also send the redemption code to the customer client device 202 to allow for mutual authentication.

In some embodiments, the vendor client device 203 authenticates the customer client device 202 prior to accepting the redemption code from the customer client device 202; for instance, in some embodiments, the vendor client device 203 receives a UUID or GUID from the customer client device 202 and compares that identifier to an identifier of the at least one user stored in memory accessible to the vendor client device 203. The vendor client device 203 may also convey the identifier supplied by the customer client device 202 to the server 201 for authentication. In other embodiments, the identifier from the customer client device 202 is sent to the vendor client device 203 by way of the server 201. The server 201 may also authenticate the customer client device. The customer client device 202 may also send other information that aids in authentication; for instance, the customer client device may generate a digital signature, either in making a handshake with the server 201 as described above in connection with FIGS. 1A-B, or by sending a digital signature or certificate to the vendor client device 203.

In some embodiments, triggering the exchange of the redemption code using the direct transmission of the vendor identifier from the vendor client device 203 to the customer client device 202 permits the at least one user to redeem the discount offer without revealing its amount or other terms to other users. Thus, two users in the same facility may simultaneously use different discount amounts without either being the wiser; this may prevent discord between users or between users and vendors. In addition, other consumers who are paying full price may remain unaware that some consumers are receiving a discount; likewise, where discount amounts are personalized as described above, consumers may be kept unaware of the particular discounts offered to other consumers.

The system 200 may process the discount offer for the at least one user. For instance, where the vendor client device 203 is integrated into the payment processing system of the vendor, the payment processing system may automatically apply the discount to the user's bill. The system 200 may also decrement the number of perishable items for the discount offers; this may be performed by the vendor client device 203 or the server 201, or both, depending where the number of perishable items is maintained.

Some embodiments of the method 300, where the at least one user has entered an instruction indicating that the at least one user is going to redeem the discount offer, further include determining, by the system 200, that the at least one user is not going to redeem the discount offer. The vendor client machine 203 or the server 201 may make this determination. In some embodiments, the system 200 determines that the at least one user is not going to redeem the discount offer because the hold period expires. In other embodiments, the system 200 determines that the at least one user is not going to redeem the offer because data from the customer client device 202 indicates that the at least one user is not going to arrive within the hold period. The data may include navigation data, such as GPS data. The data may include motion detection data, such as data generated by accelerometers or similar devices coupled to the customer client device 202. The customer client device 202 may send this data periodically to the server 201, providing the system 200 with the ability to determine whether the at least one user is getting closer to or farther from the vendor, and predict whether the at least one user is going to arrive at the vendor within the hold period. The system 200 may also collect data from other sources, such as data concerning traffic patterns in the region, and map data concerning the region. The system 200 may combine several kinds of data to determine that the at least one user will not arrive to redeem the discount offer. For instance, the accelerometer and navigation data, combined with map data, may show that the at least one user is in a car driving on a particular street a certain distance from the vendor, while the traffic data may indicate that the at least one user could not arrive from that distance, under current conditions, before the hold period expired. As another example, the navigation, accelerometer, and map data may indicate that the at least one user is travelling rapidly away from the region, consistently with the at least one user going to a different location from the vendor. In another embodiment, the at least one user, having decided not to redeem the discount or having realized that the at least one user will be unable to redeem the discount, sends the System 200 information indicating that the at least one user is not going to redeem the discount offer. In some embodiments, the system 200 retains data concerning customers' claim and redemption of discounts; this may prevent the vendor from claiming the discounts were not redeemed and attempting to avoid paying fees to the proprietor of the system 200.

In some embodiments, when the system 200 determines that the at least one user is not going to redeem the discount offer, the system 200 removes the reservation of the at least one perishable item; in other words, the system 200 increases the number of perishable items available by a number equal to the number of perishable items reserved for the at least one user. In some embodiments, the system 200 transmits an offer of discount to at least one additional user. The at least one additional user may be selected as described above for the selection of the at least one user in connection with FIG. 3.

In some embodiments, after the vendor client device 203 verifies that the customer client device 202 belongs to the at least one user, the system 200 determines that the at least one user is not going to pay for the service. In some embodiments, the system 200 has a time period within which the at least one user would pay for the service; for instance, where the service is one that is paid for before use, such as a show in a theater, the at least one user may have a few minutes to purchase a ticket upon entering the venue. In other embodiments, the system 200 maintains a numerical value corresponding to a minimum amount of time the at least one user will spend in the venue if the at least one user intends to make use of the service; for instance, there may be a minimum amount of time a person takes to eat at a restaurant, such as 30 minutes, and the at least one user may leave the venue after a shorter period of time, such as 10 minutes. The system 200 may determine that the at least one user has left because the customer client device 202 has lost contact with the vendor client device 203. In other embodiments, the system 200 determines that the at least one user has left the venue based on navigation or motion data from the customer client device 202 indicating that the at least one user has moved away from the venue. In some embodiments, if the system 200 detects that the customer has left the venue, and detects using similar means that the customer has returned to the venue in less than a certain period of time, then the system will interpret the user's absence as indicating the user will not pay; for instance, the user may be able to leave for up to 10 minutes to retrieve something from a vehicle. The system 200 may determine that the at least one user is not going to pay for the service because the vendor enters an instruction on the vendor client device 203 indicating that the at least one user is not going to pay for the service. The system 200 may determine that the at least one user is not going to pay because the at least one user enters an instruction on the customer client device 202 or the vendor client device 203 indicating that the at least one user is not going to pay for the service.

In some embodiments, when the system 200 determines that the at least one user is not going to pay for the service, the system 200 frees up the at least one perishable item that was reserved to the user after the authentication of the customer client device 202; in other words, the system 200 may increase the number of available perishable items for discount offers by the number of perishable items that the at least one user was going to use. In some embodiments, the system 200 transmits an offer of discount to at least one additional user. The at least one additional at least one user may be selected as described above for the selection of the at least one user in connection with FIG. 3.

In some embodiments, when one user of the at least one user attempts to redeem the offer of discount, the offer of discount is no longer available. For instance, the at least one user may enter an instruction in the customer client device 202 indicating that the at least one user intends to redeem the offer of discount after all available perishable items have been reserved to other users. The at least one user may arrive at the venue, causing the customer client device 202 to transmit to the vendor client device 203, after all the perishable items have been reserved to other users that arrived in the venue first; the system 200 may have overbooked reservations as described above in reference to FIG. 3. In other embodiments, the at least one user enters the instruction or arrives at the venue after the duration has elapsed. In other embodiments, the at least one user arrives at the venue after the hold period has elapsed.

When the at least one user attempts to redeem a discount offer that is no longer available, the system 200 may put the at least one user on a waitlist; the system 200 may transmit to the at least one user a message that the at least one user will be offered the discount offer if any perishable item becomes available again. For instance, where all the perishable items have been reserved, but the duration has not elapsed, the system 200 may determine that one of the users that reserved a perishable item will not arrive within that user's hold period, or will not pay for the service, as described above in reference to FIG. 3; the system 200 may transmit the offer of discount to the at least one user on the wait list in that case. In other embodiments, the system 200 transmits, to the customer client device 202, a compensatory offer. The compensatory offer may include an offer of discount at an additional vendor; the additional vendor may be within a certain distance of the vendor. The additional vendor may provide a similar service to the vendor. In some embodiments, the system 200 transmits a message to the at least one user enabling the at least one user to choose between discount offers from several different additional vendors, so that the at least one user can select the one that best suits the user's needs. In other embodiments, the compensatory offer is an offer at the first vendor; the compensatory offer may be a different discount usable upon transmission. The compensatory offer may be an offer to provide the at least one user with an offer of discount at a future time. As an example, the system 200 may track the user location and determine whether the user was moving toward the vendor some threshold proportion, such as 50%, of the hold time; if the user was attempting to get to the vendor for less than the threshold proportion, the system 200 may provide a lesser compensatory offer, because the user was apparently not trying to redeem the original offer of discount.

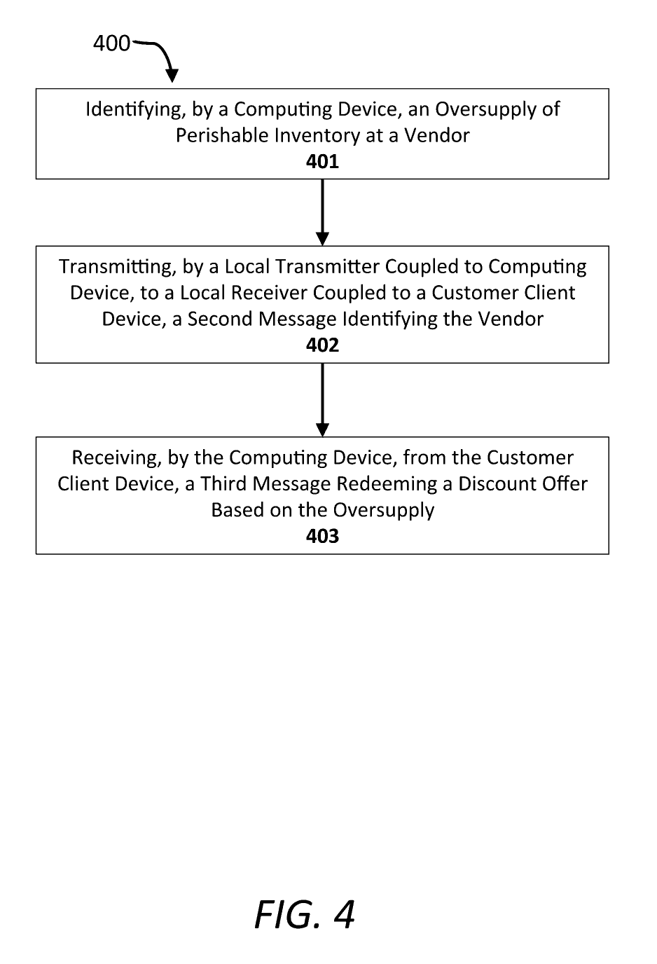

FIG. 4 illustrates some embodiments of a method 400 for generation of dynamically priced discount offers for perishable inventory to vendor-selected customer segments. The method 400 includes conveying, by a vendor client device, to a server, a first message identifying an oversupply (401). The method 400 includes transmitting, by a local transmitter coupled to the vendor client device, to a local receiver coupled to a customer client device, a second message identifying the vendor client device (402). The method 400 includes receiving, by the vendor client device, from the customer client device, a third message redeeming a discount offer based on the oversupply (403).

Referring to FIG. 4 in greater detail, and by reference to FIG. 2, the method 400 includes conveying, by a vendor client device, to a server, a first message identifying an oversupply (401). In some embodiments, this is implemented as described above in reference to FIG. 3.

The method 400 includes transmitting, by a local transmitter coupled to the vendor client device, to a local receiver coupled to a customer client device, a second message identifying the vendor client device (402). In some embodiments, this is implemented as described above in reference to FIG. 3.

The method 400 includes receiving, by the vendor client device, from the customer client device, a third message redeeming a discount offer based on the oversupply (403). In some embodiments, this is implemented as described above in reference to FIG. 3.

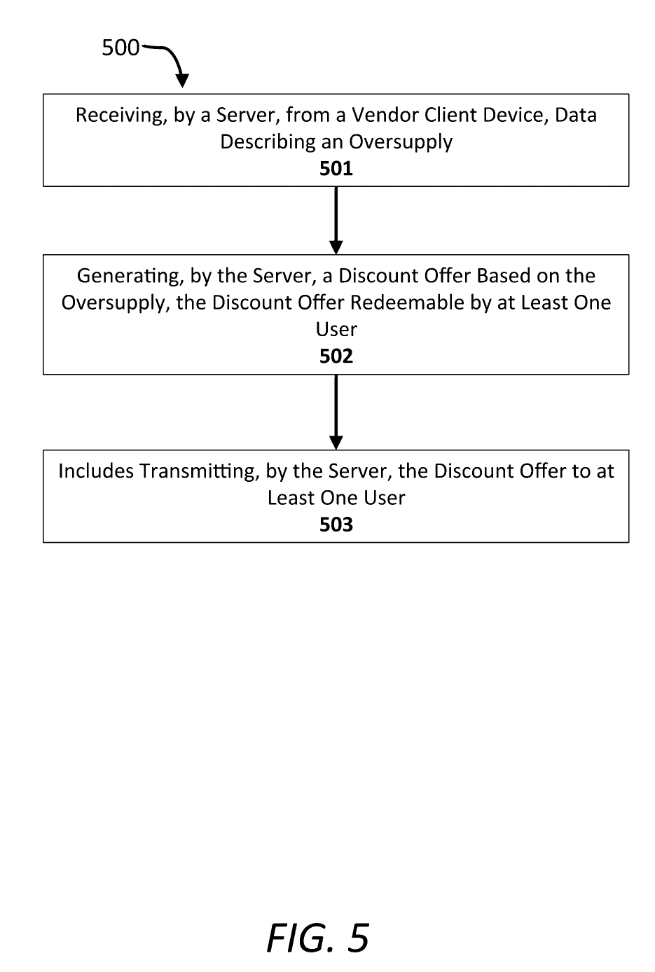

FIG. 5 illustrates some embodiments of a method 500 for real-time generation of discount offers for service. The method 500 includes receiving, by a server, from a vendor client device, data describing an oversupply (501). The method 500 includes generating, by the server, a discount offer based on the oversupply, the discount offer redeemable by at least one user (502). The method 500 includes transmitting, by the server, the discount offer to at least one user (503).

Referring to FIG. 5 in greater detail, and by reference to FIG. 2, the method 500 includes receiving, by a server, from a vendor client device, data describing an oversupply (501). In some embodiments, this is implemented as described above in reference to FIG. 3.

The method 500 includes generating, by the server, a discount offer based on the oversupply, the discount offer redeemable by at least one user (502). In some embodiments, this is implemented as described above in reference to FIG. 3.

The method 500 includes transmitting, by the server, the discount offer to at least one user (503). In some embodiments, this is implemented as described above in reference to FIG. 3.

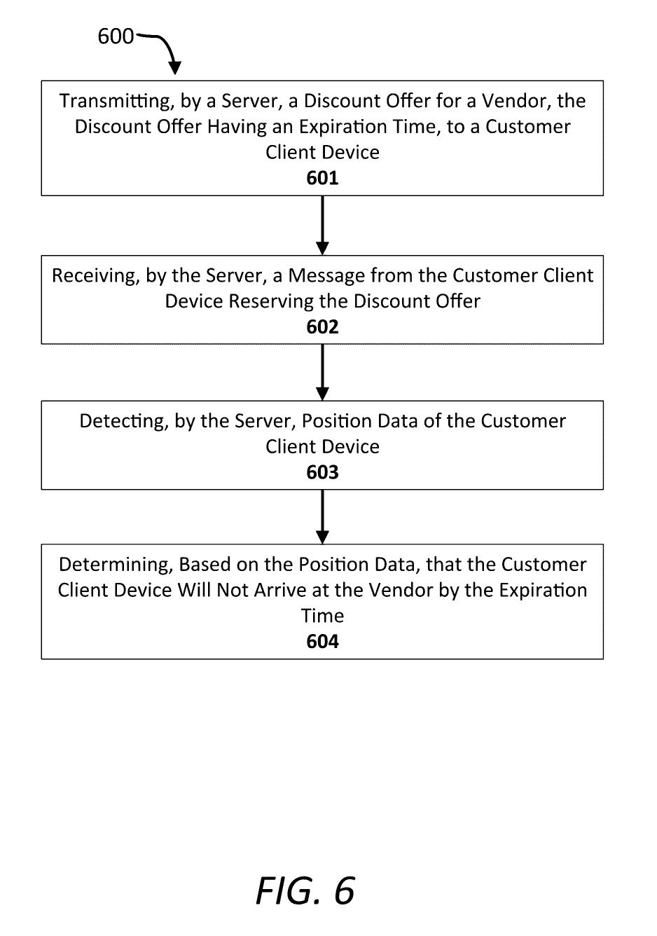

FIG. 6 illustrates some embodiments of a method 600 for real-time generation of discount offers for service. The method 600 includes transmitting, by a server, a discount offer for a vendor, the discount offer having an expiration time, to a customer client device (601). The method 600 includes receiving, by the server, a message from the customer client device reserving the discount offer (602). The method 600 detecting, by the server, position data of the customer client device (603). The method 600 determining, based on the position data, that the customer client device will not arrive at the vendor by the expiration time (604).

Referring to FIG. 6 in greater detail, and by reference to FIG. 2, the method includes transmitting, by a server, a discount offer for a vendor, the discount offer having an expiration time, to a customer client device (601). In some embodiments this is implemented as described above in connection with FIG. 3.

The method 600 includes receiving, by the server, a message from the customer client device reserving the discount offer (602). In some embodiments this is implemented as described above in connection with FIG. 3.

The method 600 detecting, by the server, position data of the customer client device (603). In some embodiments this is implemented as described above in connection with FIG. 3. Position data, as used herein, is any data describing the geographical position, magnitude of velocity, direction of velocity, magnitude of acceleration, or direction of acceleration. Position data may include navigation data as described above in connection with FIG. 3. Position data may include data obtained from a motion detector such as an accelerometer, magnetometer, gyroscope, or inertial measurement unit, as described above in connection with FIG. 3.

The method 600 determining, based on the position data, that the customer client device will not arrive at the vendor by the expiration time (604). In some embodiments this is implemented as described above in connection with FIG. 3.

Although the foregoing systems and methods have been described in some detail for purposes of clarity of understanding, it will be apparent that certain changes and modifications may be practiced within the scope of the appended claims.

What is claimed is:

1. A method for generation of dynamically priced discount offers for perishable inventory to vendor-selected customer segments, the method comprising:
identifying, by a computing device, an oversupply of perishable inventory at a vendor;
directly transmitting, by local transmitter coupled to the computing device, to a local receiver coupled to a customer client device, a second message identifying the vendor; and
receiving, by the computing device, from the customer client device, a third message redeeming a discount at the vendor.

2. The method of claim 1 wherein identifying further comprises calculating a number of consumers necessary to eliminate the oversupply.

3. The method of claim 1, wherein directly transmitting further comprises periodically broadcasting a signal identifying the vendor.

4. The method of claim 1, wherein directly transmitting further comprises detecting a signal transmitted by the client device and broadcasting a signal identifying the vendor in response to the detected signal.

5. The method of claim 4, wherein the signal transmitted by the client device further comprises a redemption code.

6. The method of claim 1, wherein directly transmitting further comprises generating a unique identifier.

7. The method of claim 1, wherein receiving further comprises receiving a redemption code from the customer client device.

8. The method of claim 7, wherein receiving the redemption code further comprises scanning the redemption code from a display of the customer client device.

9. The method of claim 7, wherein receiving the redemption code further comprises receiving the redemption code by local transmission.

10. The method of claim 1, further comprising authenticating, by the vendor client device, the customer client device.

11. The method of claim 1 further comprising authenticating, by the customer client device, the vendor.

12. The method of claim 1 further comprising determining, by the computing device, that the discount has expired.

13. The method of claim 12 further comprising transmitting, by the computing device, a compensatory offer to the customer client device.

14. The method of claim 1, further comprising:
selecting, by the computing device, the customer client device; and
conveying, by the computing device, to the customer client device, the discount offer.

15. The method of claim 14, wherein selecting further comprises:
locating, by the computing device, position data of a client device used by a user;
determining that the location is closer than a threshold amount; and
selecting the user based on the determination.

16. The method of claim 14, wherein selecting further comprises:
determining that the user has used the vendor in the past; and
selecting the user profile from a plurality of user profiles.

17. The method of claim 14, wherein selecting further comprises:
determining that the user has purchased inventory similar to the perishable inventory in the past; and
selecting the user profile from a plurality of user profiles.

18. The method of claim 14, wherein selecting the user further comprises:
assigning a rank to each of a plurality of users that includes the user; and
determining that the user has a high rank.

19. The method of claim 18, wherein the rank represents proximity of a client device used by each user to the vendor.

20. The method of claim 14 further comprising:
calculating, by the computing device, the probability that a user will redeem the discount offer; and
selecting enough users as the at least one user to make the probability that all oversupply substantially equal to one.
